(19) United States
(12) Patent Application Publication
(10) Pub. No.: US 2024/0296660 A1
(43) Pub. Date: Sep. 5, 2024

(54) COMPUTER-READABLE RECORDING MEDIUM STORING MACHINE LEARNING PROGRAM, MACHINE LEARNING APPARATUS, AND MACHINE LEARNING METHOD

(71) Applicant: Fujitsu Limited, Kawasaki-shi (JP)

(72) Inventor: Yoshihiro OKAWA, Yokohama (JP)

(73) Assignee: Fujitsu Limited, Kawasaki-shi (JP)

(21) Appl. No.: 18/664,416

(22) Filed: May 15, 2024

Related U.S. Application Data
(63) Continuation of application No. PCT/JP2021/048388, filed on Dec. 24, 2021.

(51) Int. Cl. G06V 10/764; G06V 10/774; G06V 20/70

(52) U.S. Cl. CPC G06V 10/764; G06V 10/774; G06V 20/70

(57) ABSTRACT

A non-transitory computer-readable recording medium stores a machine learning program for causing a computer to execute processing including: in a case where a machine learning model classifies a first image based on a value less than a threshold, generating training data in which a classification result of a second region of a second image that corresponds to a position of a first region of the first image is labeled to the first region, based on a classification result obtained by classifying the second image based on a value equal to or more than the threshold by the machine learning model; and training the machine learning model based on the training data.

### CROSS-REFERENCE TO RELATED APPLICATION

This application is a continuation application of International Application PCT/JP2021/048388 filed on Dec. 24, 2021 and designated the U.S., the entire contents of which are incorporated herein by reference.

### FIELD

The disclosed technology discussed herein is related to a machine learning program, a machine learning apparatus, and a machine learning method.

### BACKGROUND

In recent years, a machine learning model has been introduced to processing such as data determination or classification executed by systems used in companies or the like. The machine learning model performs data determination, classification, or the like based on training data used at the time of training when the system is developed. Therefore, when tendency of operation data used during system operation is changed from tendency of the training data, determination accuracy, classification accuracy, or the like of the machine learning model decreases. In order to maintain the accuracy of the machine learning model during system operation, a value indicating the accuracy such as a correct answer rate is calculated by periodically and manually, for example, by confirming by human whether or not an output result of the machine learning model is correct or incorrect. Then, in a case where the value decreases, the system is manually confirmed whether the system is correct or incorrect, and the machine learning model is trained using the training data to which a correct answer label is assigned.

Yang Zou, Zhiding Yu, B. V. K. Vijaya Kumar, and Jinsong Wang, “Unsupervised Domain Adaptation for Semantic Segmentation via Class-Balanced Self-Training”, Proceedings of the European Conference on Computer Vision (ECCV), 2018, pp. 289-305. and Yunsheng Li, Lu Yuan, and Nuno Vasconcelos, “Bidirectional Learning for Domain Adaptation of Semantic Segmentation”, Proceedings of the IEEE/CVF Conference on Computer Vision and Pattern Recognition (CVPR), 2019, pp. 6929-6938. are disclosed as related art.

### SUMMARY

According to an aspect of the embodiments, a non-transitory computer-readable recording medium stores a machine learning program for causing a computer to execute processing including: in a case where a machine learning model classifies a first image based on a value less than a threshold, generating training data in which a classification result of a second region of a second image that corresponds to a position of a first region of the first image is labeled to the first region, based on a classification result obtained by classifying the second image based on a value equal to or more than the threshold by the machine learning model; and training the machine learning model based on the training data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a decrease in accuracy of a machine learning model;

FIG. 2 is a diagram for explaining semantic segmentation;

FIG. 3 is a diagram for explaining a decrease in accuracy of a machine learning model in a semantic segmentation task;

FIG. 4 is a functional block diagram of a machine learning apparatus;

FIG. 5 is a diagram for explaining each processing of the machine learning apparatus;

FIG. 6 is a diagram for explaining generation of a synthetic pseudo label;

FIG. 7 is a diagram for explaining labeling to an image of which a classification result is “poor”;

FIG. 8 is a graph illustrating a transition of the accuracy of the machine learning model during operation;

FIG. 9 is a block diagram illustrating a schematic configuration of a computer that functions as the machine learning apparatus;

FIG. 10 is a flowchart illustrating an example of machine learning processing;

FIG. 11 is a schematic diagram illustrating an image example and a classification result example in a case where a situation has been changed;

FIG. 12 is a schematic diagram illustrating an image example and a classification result example in a case where the situation has been changed;

FIG. 13 is a diagram illustrating generation of training data in an application example;

FIG. 14 is a schematic diagram illustrating an image example, a classification result, and an example of accuracy in the application example; and

FIG. 15 is a schematic diagram illustrating an image example, a classification result, and an example of the accuracy in the application example.

### DESCRIPTION OF EMBODIMENTS

Furthermore, as a technology for, for example, determining or classifying data by the machine learning model, there is a technology called semantic segmentation for dividing an image into regions for each type of a subject by performing class classification on the type of the subject for each small region such as pixel units of the image. In a semantic segmentation task, as in the above, during the system operation using the machine learning model, there is a case where the accuracy of the machine learning model decreases due to a change in the operation data. On the other hand, a technology has been proposed for assuming operation data after being changed during system operation and preparing the operation data in advance and using training data including the changed operation data for training of a machine learning model used by a system.

As described above, in a semantic segmentation task, class classification into each small region such as pixel unit is performed. Therefore, in a case where a correct answer label is assigned to operation data during system operation, operation cost becomes enormous. Furthermore, in a case where it is unknown how the operation data changes during the system operation, it is difficult to prepare changed operation data in advance and train a machine learning model.

As one aspect, an object of the disclosed technology is to maintain accuracy of a machine learning model in a semantic segmentation task.

Hereinafter, an example of an embodiment according to the disclosed technology will be described with reference to the drawings.

First, before describing details of the embodiment, a decrease in accuracy of a machine learning model during system operation will be described.

For example, in training of a machine learning model used in an image classification system for estimating a subject imaged in an image, features on the image useful in classification are trained from the image that is training data. However, there is a case where features of an image input into the system at the time of operation are changed from features of an image at the time of training the machine learning model. As cause for this, for example, that a surface of a camera that images the image is contaminated, a position is shifted, sensitivity is deteriorated, or the like is exemplified. Due to such a change in the features of the image acquired at the time of operation, the decrease in the accuracy of the machine learning model occurs. For example, a machine learning model at the beginning of operation has accuracy of a correct answer rate 99%, and the accuracy decreases to accuracy of a correct answer rate 60% after a predetermined period has elapsed from the beginning of the operation.

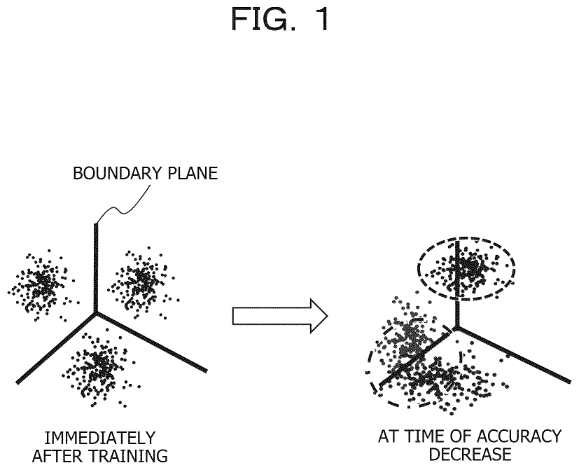

The causes of such a decrease in the accuracy will be described. FIG. 1 illustrates a schematic diagram in which a boundary plane for each label and a feature amount extracted from each image are projected in a feature amount space. As illustrated in the left diagram in FIG. 1, immediately after the training of the machine learning model, the feature amount is clearly divided for each label with the boundary plane in the feature amount space. Then, as illustrated in the right diagram in FIG. 1, in a case where the feature of the acquired image changes, a feature amount extracted from the image moves to a region of a different label (broken line portion in FIG. 1) or a plurality of regions of labels is connected (one-dot chain line portion in FIG. 1). Therefore, a classification result by the machine learning model is likely to be erroneous, and the accuracy decreases.

Here, a distribution of the feature amount in the feature amount space has features such that a distribution of the feature amount of the same label includes a single or a plurality of high-density points and the density often decreases toward an outer side of the distribution. Therefore, the following reference method is considered for automatically labeling an image that is operation data, using the features. The reference method calculates a density for each cluster of the feature amounts of each label, in the feature amount space before the accuracy decrease and records the number of clusters. Furthermore, the reference method records a center of a region of which a density is equal to or higher than a certain density in each cluster or a point with the highest density as a cluster center. Then, the reference method calculates the density of the feature amount of the image that is the operation data, for each point in the feature amount space, after the operation. The reference method extracts a feature amount included in a region of which the density is equal to or higher than a threshold as a cluster, in the feature amount space. Then, the reference method searches for a minimum threshold at which the number of clusters to be extracted becomes the number of clusters recorded before the accuracy decrease, by changing the threshold. The reference method performs matching between a cluster center of each cluster clustered at the time of minimum threshold and a cluster center recorded before the accuracy decrease. Then, the reference method assigns a label corresponding to the cluster before the accuracy decrease to an image corresponding to the feature amount included in the matched cluster. As a result, the operation data image is labeled. The reference method suppresses the accuracy decrease in the machine learning model during operation, by training the machine learning model, using the labeled operation data.

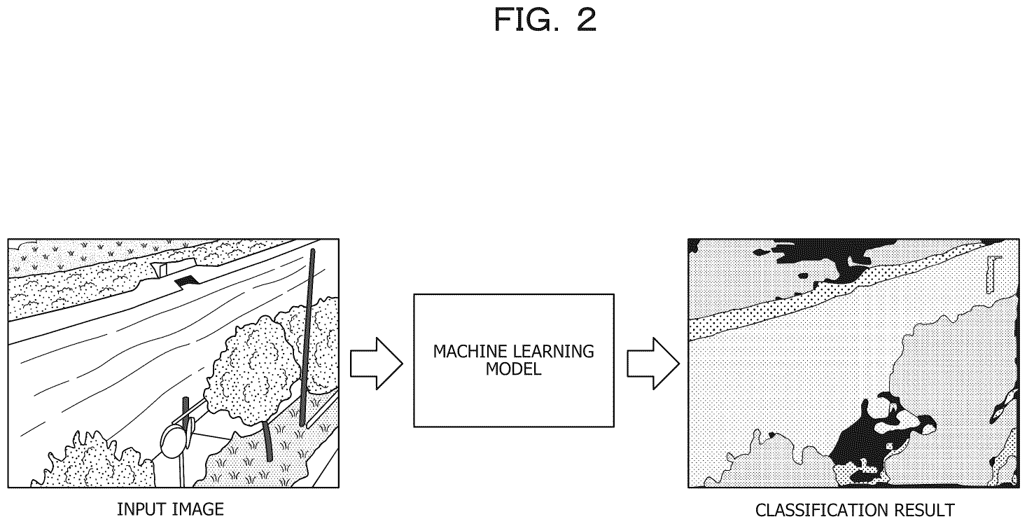

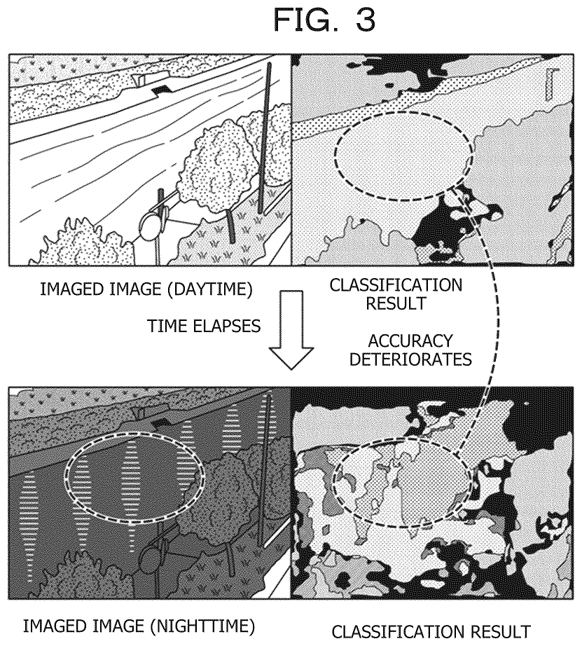

Furthermore, here, a semantic segmentation task is considered. As illustrated in FIG. 2, the semantic segmentation is a technology for inputting an input image into the machine learning model and classifying a type of a subject into a class for each small region such as pixel unit of the image so as to output a classification result in which the image is divided into the regions for each type of the subject. As illustrated in FIG. 3, in the semantic segmentation task, similarly to the image classification problem above, the accuracy of the machine learning model decreases, due to a situation change such as a lapse of time or a weather at the time of operation. FIG. 3 illustrates an example in which an image imaged at night time is input into a system using a machine learning model trained using an image imaged outdoors in daytime as training data, at the time of operation. For example, the accuracy of the machine learning model decreases, due to a brightness change between the daytime image and the nighttime image, existence of reflection of light from an outdoor lamp or the like, which does not exist in the daytime image, in the nighttime image (broken line portion in FIG. 3), or the like.

It is considered to apply the above reference method to the accuracy decrease at the time of operation in such a semantic segmentation task. However, in the semantic segmentation, the class classification is performed in small region unit, such as each pixel in the image. Therefore, the number of instances to be used during the operation becomes enormous, and it is difficult to perform clustering as in the reference method. For example, in a case where 100 images including 320 pixels×240 pixels are processed in each batch, the number of instances to be clustered is 100 in a case of the image classification problem. On the other hand, in a semantic segmentation problem, the number of instances is 320×240×100=7,680,000.

Therefore, in the present embodiment, appropriate labeling is performed following the change in the operation data at the time of operation, without using clustering as in the reference method. Hereinafter, a machine learning apparatus according to the present embodiment will be described. Note that, in the following embodiment, a semantic segmentation problem for performing class classification on each pixel of an image will be described as an example.

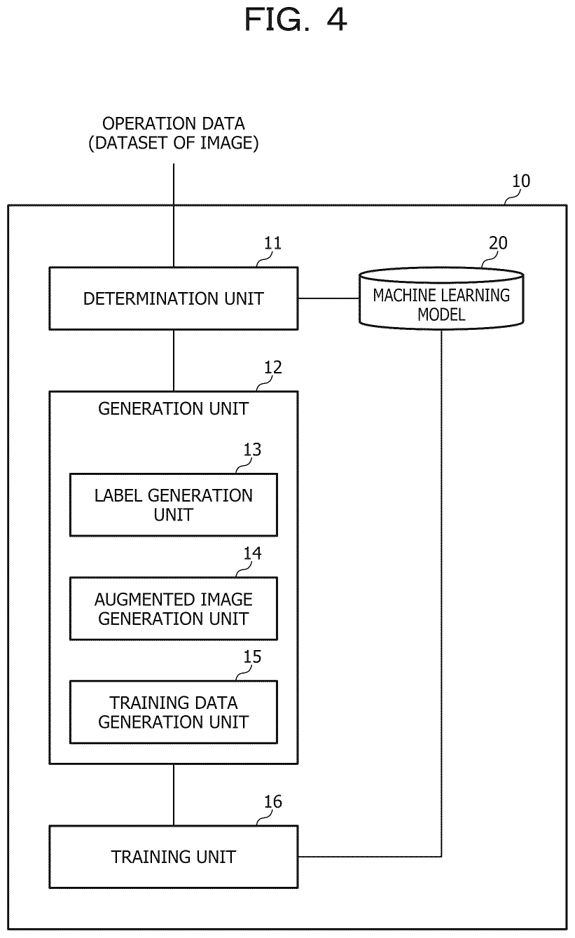

As illustrated in FIG. 4, a dataset of an image is input into a machine learning apparatus 10 as operation data. The machine learning apparatus 10 functionally includes a determination unit 11, a generation unit 12, and a training unit 16. The generation unit 12 further includes a label generation unit 13, an augmented image generation unit 14, and a training data generation unit 15. Furthermore, in a predetermined storage region of the machine learning apparatus 10, a machine learning model 20 is stored.

The machine learning model 20 is a machine learning model used to execute a semantic segmentation task in an operating system. The machine learning model 20 includes, for example, a deep neural network (DNN) or the like.

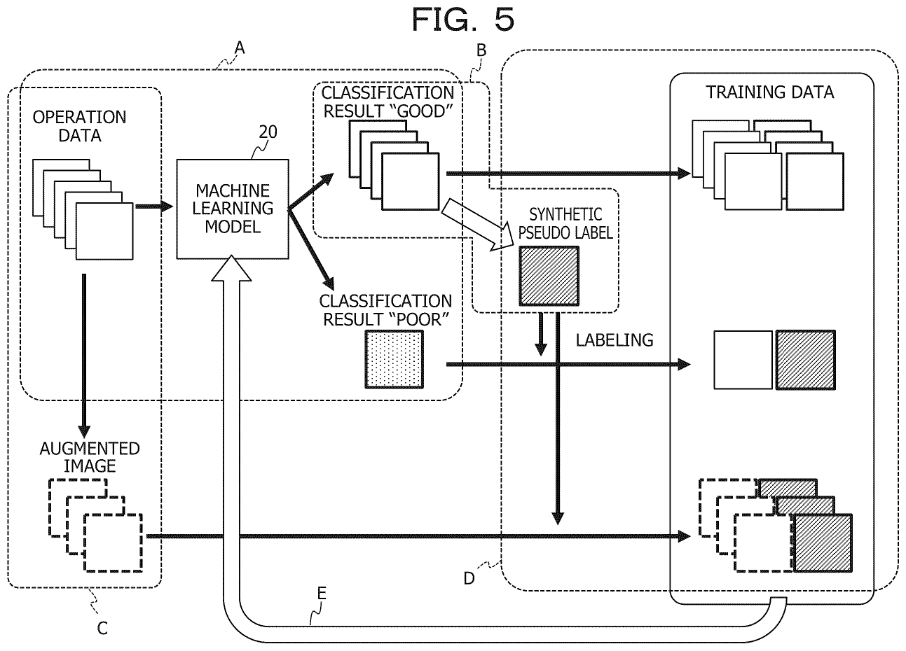

As illustrated in A of FIG. 5, the determination unit 11 acquires the dataset of the image that is the operation data input into the machine learning apparatus 10. For each acquired image, the determination unit 11 acquires a classification result obtained by performing class classification on each pixel using the machine learning model 20. Then, the determination unit 11 determines quality of the classification result for each image. For example, the determination unit 11 calculates a classification score indicating confidence of the classification result, together with the classification result. For example, in a case where the machine learning model 20 is a DNN, the classification score may be a score based on an output value of a layer one layer preceding the final layer, for example, a value before a softmax function is applied.

For example, in a case of a semantic segmentation problem for performing class classification into N classes, it is assumed that a classification score vector v_{(x_i, k, l)} obtained from the machine learning model 20 be expressed by the following formula (1), for a pixel (k, l) of an image x_i. In this case, a classification score S_{(x_i, k, l)} may be expressed by the following formula (2).

v_{(x_i, k, l)}=[s_{(x_i, k, l, 1)}, . . . ,s_{(x_i, k, l, N)}] (1)

S_{(x_i, k, l)}=arg maxₛ(s_{(x_i, k, l, 1)}, . . . ,s_{(x_i, k, l, N)} (2)

However, s_{(x_i, k, l, n)} (n=1, . . . , N) is a probability that the pixel (k, l) of the image x_i is in a class n.

The determination unit 11 calculates an average value of the classification scores for all the pixels in the image. If the average value is equal to or more than the threshold, the determination unit 11 determines a classification result of the image as “good”, and if the average value is less than the threshold, the determination unit 11 determines the classification result of the image as “poor”. As a result, it is possible to determine a decrease in accuracy of the machine learning model 20 at the time of operation, without teacher data. Note that, the image of which the classification result is “poor” is an example of a “first image” according to the disclosed technology, and the image of which the classification result is “good” is an example of a “second image” according to the disclosed technology.

The generation unit 12 generates training data used to retrain the machine learning model 20. Hereinafter, each of the label generation unit 13, the augmented image generation unit 14, and the training data generation unit 15 will be described in detail.

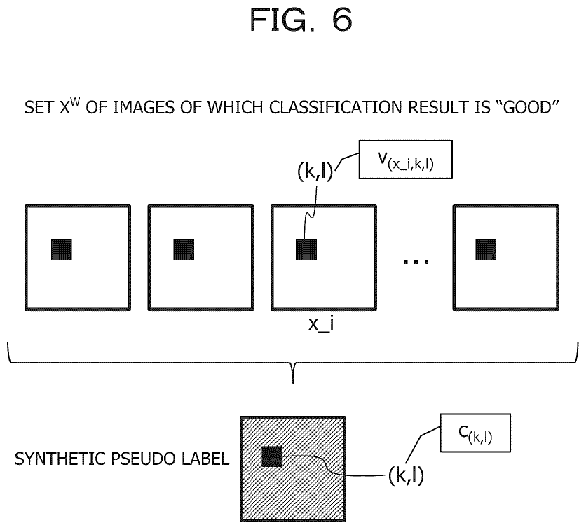

As illustrated in B of FIG. 5, the label generation unit 13 generates a synthetic pseudo label using classification results of images imaged at the same imaging place and in the same imaging direction, among the images of which the classification result is “good”. For example, as illustrated in FIG. 6, the label generation unit 13 generates a synthetic pseudo label c_{(k, l)} for the pixel (k, l), as indicated in the following formula (3), using the classification score vector v_{(x_i, k, l)} of the pixel (k, l) of each image x_i included in a set X^{W} of the images of which the classification result is “good”.

$$\begin{matrix}[ Expression 1 ] & \\ {c}_{( k , l )} = arg {max}_{j ∈ \{ 1 , 2 , … , N \}} {\sum }_{x\_i ∈ {𝒳}^{w}} {s}_{( x\_i , k , l , j )} & ( 3 )\end{matrix}$$

For example, the label generation unit 13 generates a label corresponding to a class of which a sum of probabilities for each element of the classification score vector, for example, for each class is the largest, for each pixel (k, l) of the image x_i∈X^{W}, as the synthetic pseudo label c_{(k, l)} of the pixel (k, l).

As illustrated in C of FIG. 5, the augmented image generation unit 14 generates an augmented image obtained by augmenting the image of the operation data. As a method for generating the augmented image, a typically known method may be adopted. For example, the augmented image generation unit 14 may generate an augmented image by an a blending of the image of which the classification result is “good” and the image of which the classification result is “poor”. Note that, in a case of generating the augmented image by combining two or more images, the augmented image generation unit 14 uses the images imaged at the same imaging place and in the same imaging direction.

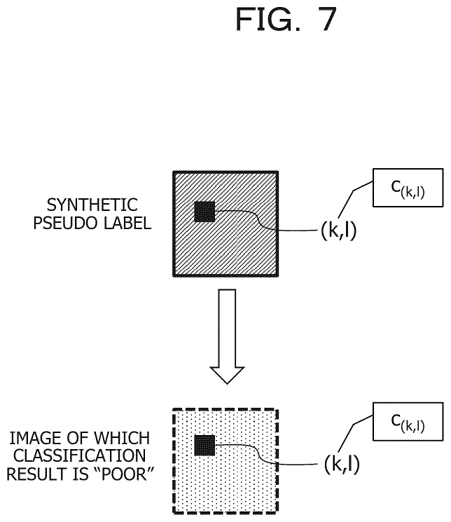

As illustrated in D of FIG. 5, for the image of which the classification result is “good”, the training data generation unit 15 generates training data by labeling the classification result of the pixel to each pixel. Furthermore, the training data generation unit 15 generates the training data, by labeling the synthetic pseudo label to each of the image of which the classification result is “poor” and the augmented image. For example, as illustrated in FIG. 7, the training data generation unit 15 assigns the synthetic pseudo label c_{(k, l)} generated from the image of which the classification result is “good” and imaged at the same imaging place and in the same imaging direction as the image, to the pixel (k, l) of the image of which the classification result is “poor”. Furthermore, for an augmented image, similarly, the training data generation unit 15 assigns the synthetic pseudo label c_{(k, l)} generated from the image of which the classification result is “good” and imaged at the same imaging place and in the same imaging direction as an original image of the augmented image, to the pixel (k, l) of the augmented image.

As illustrated in E of FIG. 5, the training unit 16 trains the machine learning model 20 using the training data generated by the generation unit 12. For example, the training unit 16 retrains the machine learning model 20 using the training data to which the classification result by the machine learning model 20 being operated at that time is labeled as a correct answer label to operation data acquired at the time of operation. The retrained machine learning model 20 is output and is applied to the operating system.

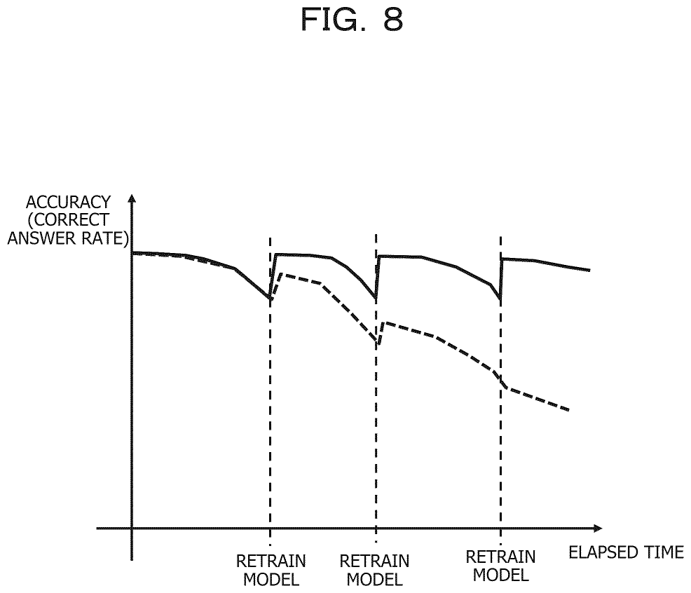

In FIG. 8, a relationship between an elapsed time during operation and the accuracy of the machine learning model is schematically illustrated. In the example in FIG. 8, a solid line indicates a transition of accuracy in a case where the classification result obtained during operation is appropriate, and a broken line indicates a transition of accuracy in a case where the classification result obtained during the operation is not appropriate. In this way, in a case where the classification result for the operation data is greatly different from a true classification result, there is a case where the accuracy is not maintained even if the model is retrained using the training data to which the classification result is labeled as the correct answer label or the accuracy conversely decreases due to retraining. In the present embodiment, after the quality of the classification result for the operation data is determined, the label based on the classification result of the image of which the classification result is “good” is assigned to the image of which the classification result is “poor”. Therefore, as in the example indicated by the solid line in FIG. 8, the decrease in the accuracy of the machine learning model during the operation can be suppressed.

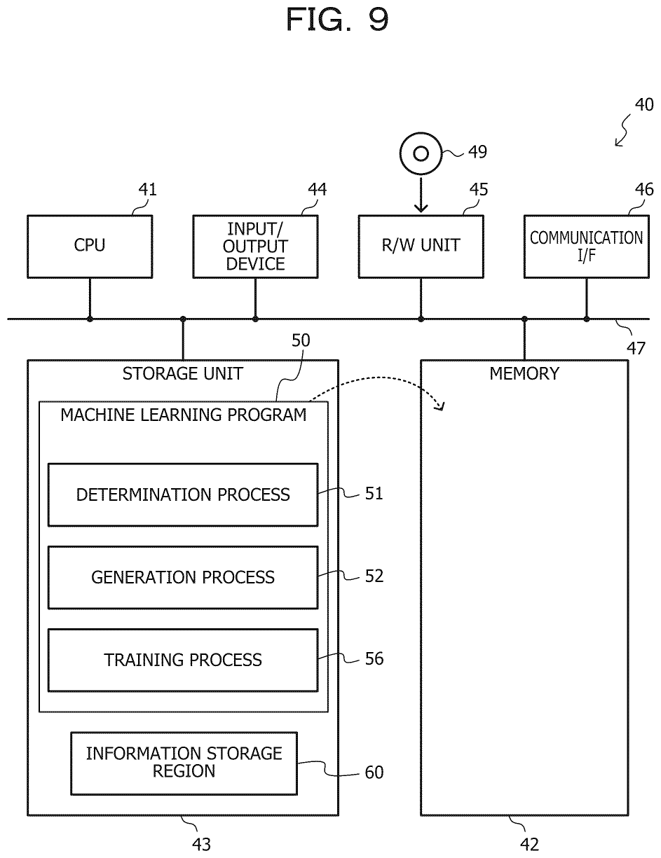

The machine learning apparatus 10 may be implemented by a computer 40 illustrated in FIG. 9, for example. The computer 40 includes a Central Processing Unit (CPU) 41, a memory 42 as a temporary storage region, and a nonvolatile storage unit 43. Furthermore, the computer 40 includes an input/output device 44 such as an input unit or a display unit, and a Read/Write (R/W) unit 45 that controls reading and writing of data from and to a storage medium 49. Furthermore, the computer 40 includes a communication interface (I/F) 46 to be coupled to a network such as the Internet. The CPU 41, the memory 42, the storage unit 43, the input/output device 44, the R/W unit 45, and the communication I/F 46 are coupled to each other via a bus 47.

The storage unit 43 may be implemented by a Hard Disk Drive (HDD), a Solid State Drive (SSD), a flash memory, or the like. The storage unit 43 as a storage medium stores a machine learning program 50 for causing the computer 40 to function as the machine learning apparatus 10. The machine learning program 50 includes a determination process 51, a generation process 52, and a training process 56. Furthermore, the storage unit 43 includes an information storage region 60 that stores information included in the machine learning model 20.

The CPU 41 reads the machine learning program 50 from the storage unit 43 to load the read machine learning program 50 into the memory 42, and sequentially executes the processes included in the machine learning program 50. The CPU 41 executes the determination process 51 to operate as the determination unit 11 illustrated in FIG. 4. Furthermore, the CPU 41 executes the generation process 52 to operate as the generation unit 12 illustrated in FIG. 4. Furthermore, the CPU 41 executes the training process 56 to operate as the training unit 16 illustrated in FIG. 4. Furthermore, the CPU 41 reads the information from the information storage region 60 and loads the machine learning model 20 into the memory 42. As a result, the computer 40 that has executed the machine learning program 50 functions as the machine learning apparatus 10. Note that the CPU 41 that executes the program is hardware.

Note that functions implemented by the machine learning program 50 may also be implemented by, for example, a semiconductor integrated circuit, more specifically, an Application Specific Integrated Circuit (ASIC), a Graphics Processing Unit (GPU), or the like.

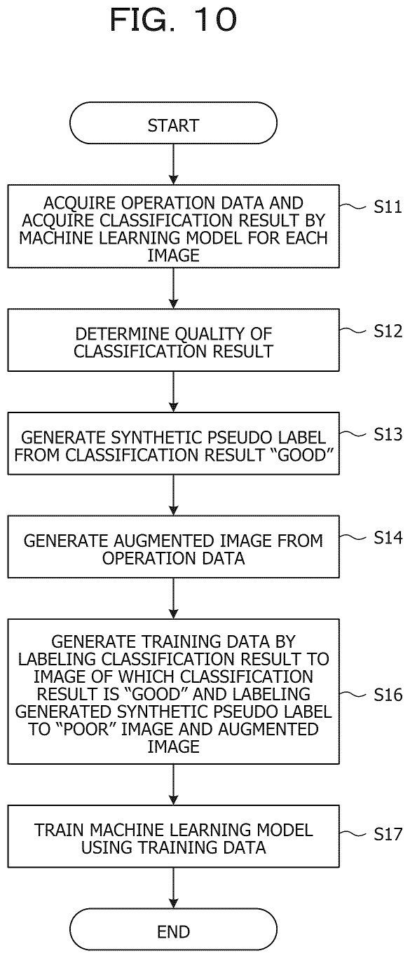

Next, workings of the machine learning apparatus 10 according to the present embodiment will be described. The machine learning model 20 used in the operating system is stored in the machine learning apparatus 10, and the dataset of the image that is the operation data is input into the machine learning apparatus 10. Then, when retraining of the machine learning model 20 is instructed, machine learning processing illustrated in FIG. 10 is executed by the machine learning apparatus 10. Note that the machine learning processing is an example of a machine learning method according to the disclosed technology.

In step S11, the determination unit 11 acquires the dataset of the image that is the operation data input into the machine learning apparatus 10. Then, for each acquired image, the determination unit 11 acquires a classification result obtained by performing class classification on each pixel using the machine learning model 20. Next, in step S12, the determination unit 11 calculates an average value of the classification score indicating the confidence of the classification result of each pixel, for all the pixels in the image and determines the classification result of the image of which the average value is equal to or more than the threshold as “good” and the classification result of the image of which the average value is less than the threshold as “poor”.

Next, in step S13, the label generation unit 13 generates the synthetic pseudo label using the classification result of the image imaged at the same imaging place and in the same imaging direction, among the images of which the classification result is “good”. Next, in step S14, the augmented image generation unit 14 generates the augmented image obtained by augmenting the image of the operation data Next, in step S16, for the image of which the classification result is “good”, the training data generation unit 15 generates the training data, by labeling the classification result of the pixel to each pixel. Furthermore, the training data generation unit 15 generates the training data, by labeling the synthetic pseudo label to each of the image of which the classification result is “poor” and the augmented image.

Next, in step S17, the training unit 16 trains the machine learning model 20, using the training data generated by the generation unit 12. Then, the machine learning processing ends.

As described above, the machine learning apparatus according to the present embodiment determines the quality of the classification result, based on the classification score of the classification result when the semantic segmentation is performed on the image that is the operation data by the machine learning model. Furthermore, the machine learning apparatus generates the training data, to which the classification result of each pixel in the image of which the classification result is “good” is labeled, corresponding to the pixel, for each pixel of the image of which the classification result is determined as “poor”, and trains the machine learning model based on the generated training data. As a result, in the semantic segmentation task, it is possible to maintain the accuracy of the machine learning model while suppressing operation cost.

Here, an application example in which the machine learning model trained by the machine learning apparatus according to the present embodiment is applied to a system that detects rise of a river will be described. A task of this application example is to perform the semantic segmentation on an image obtained by imaging the river and determines whether or not the rise of the river occurs, based on a region classified as the river (water surface). In this application example, a result of verification using a dataset of images for four days imaged at 10 to 20 minutes intervals, at each of eight non-water-increasing positions and seven water-increasing positions, among 15 imaging positions, as the operation data, will be described. Furthermore, as a verification condition, an initial machine learning model has used a Context Prior Network (CPNet) (Reference Document 1).
Reference Document 1: C. Yu, J. Wang, C. Gao, G. Yu, C. Shen, N. Sang, “Context Prior for Scene Segmentation,” IEEE Conference on Computer Vision and Pattern Recognition, pp. 12416-12425, 2020.

Furthermore, as the method for generating the augmented image, gray scaling, flipping, and random erasing have been applied. Furthermore, every 2 hours, the machine learning model has been retrained by fine tuning, using images (about 150 sheets to 250 sheets) for four hours before then and a part of training data (300 sheets) used at the time of training of the initial machine learning model. Furthermore, in fine tuning, an initial value of a training rate has been set to 0.00001, and the number of epochs has been set to 500. Note that, for reference, a time needed for the above fine tuning has been slightly less than 10 minutes for one GPU. On the other hand, at the time of training of the initial machine learning model, in a case where the initial value of the training rate is set to 0.001 and the number of epochs is set to 20000, about five hours are needed.

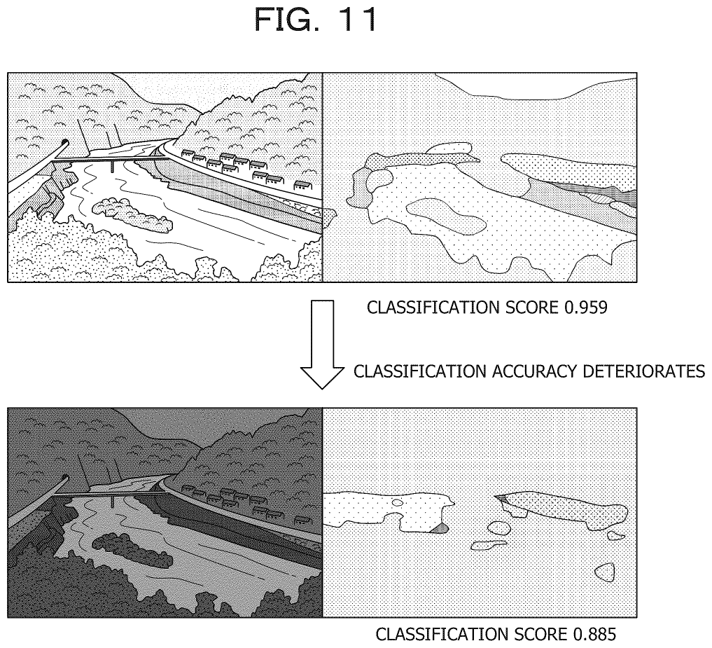

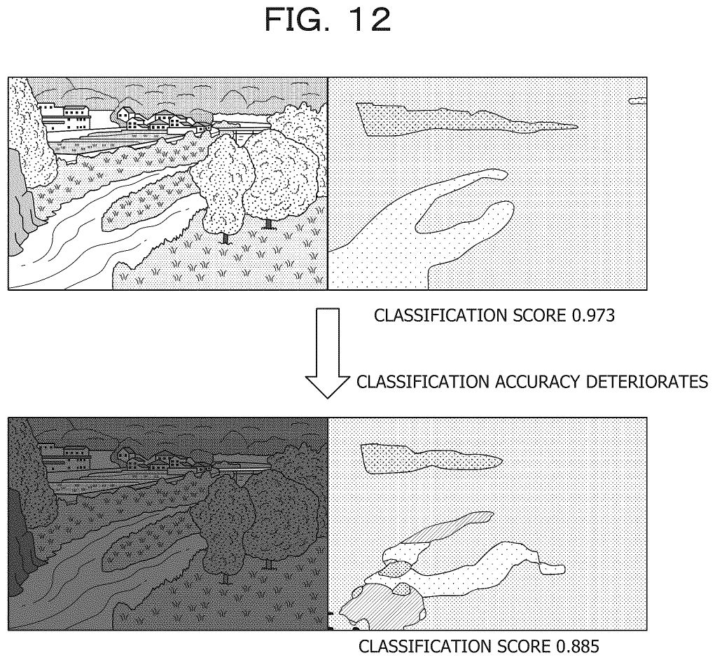

For the images imaged between 18:00 to 22:00, an average of the classification scores of the images of which the classification result is determined as “good” has been 0.946, and an average of the classification scores of the images of which the classification result is determined as “poor” has been 0.871. In FIGS. 11 and 12, a schematic diagram of an image example and a classification result example in a case where imaging times of images imaged at the same imaging place and in the same imaging direction are different, for example, there is a situation change between the two images is illustrated. The upper part of FIG. 11 is an example of an image imaged in a bright time band around 18:00, and a classification score of the classification result has been 0.959 and has been determined as “good”. On the other hand, the lower part of FIG. 11 is an example of an image imaged in a dark time band when it is getting dark, a classification score of the classification result has been 0.885 and has been determined as “poor”. FIG. 12 is also a similar image example with a situation change, and in the image example in the upper part of FIG. 12, a classification score of the classification result has been 0.973 and has been determined as “good”. On the other hand, regarding an image example in the lower part of FIG. 12, the classification score of the classification result is 0.885, and the image example has been determined as “poor”. In this way, the classification score decreases with the situation change, and it is possible to detect the decrease in the accuracy of the machine learning model without using the correct answer label.

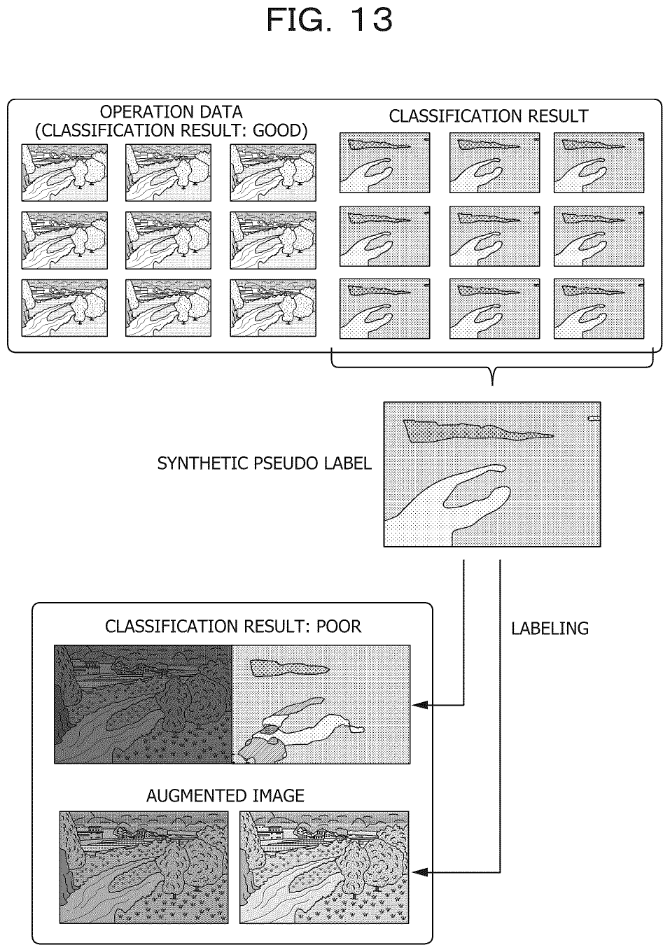

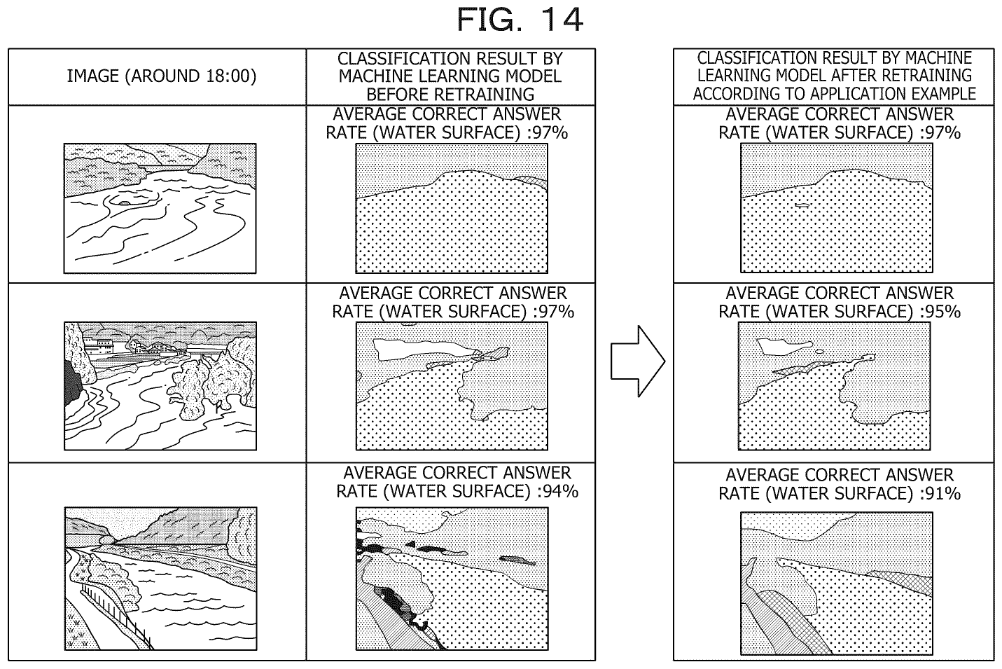

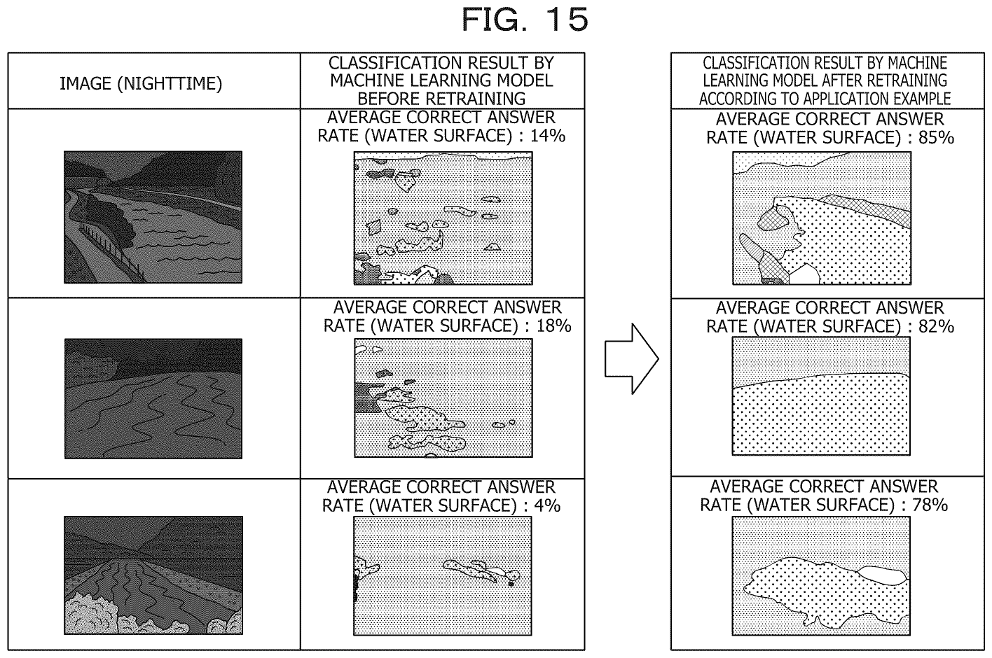

In the application example, as illustrated in FIG. 13, the synthetic pseudo label has been generated from the classification result determined as “good”, and the training data has been generated by labeling the generated synthetic pseudo label to the image of which the classification result has been determined as “poor” and the augmented image. FIGS. 14 and 15 schematically illustrate an image example, a classification result, and an example of accuracy in this case. FIG. 14 is an image example imaged in a bright time band around 18: 00, and FIG. 15 is a nighttime image example. The accuracy represents an average correct answer rate of a classification result of a class “water surface”. As illustrated in FIG. 14, for the image in the bright time band, high accuracy is maintained for both of the classification result by the machine learning model before retraining and the classification result by the machine learning model after retraining according to the application example. Furthermore, as illustrated in FIG. 15, in the nighttime image example in which the situation has changed, the accuracy of the classification result by the machine learning model before retraining significantly decreases. On the other hand, in the classification result by the machine learning model after retraining according to the application example, high accuracy is maintained. For example, even in a case where the situation changes during the operation, the application example can maintain the accuracy of the machine learning model without incurring operation cost such as manual assignment of a correct answer label.

Note that, in the above embodiment, a case has been described where the class classification is performed for each pixel of the image as the semantic segmentation. However, the class classification is not limited to pixel unit. For example, class classification may be performed in small region units such as two pixels×two pixels or three pixels×three pixels.

Furthermore, in the above embodiment, a case has been described where the images imaged at the same imaging place and in the same imaging direction are processed as targets in the processing for generating the synthetic pseudo label and the processing of labeling. However, the embodiment is not limited to this. Even in a case of the images imaged at different imaging places and in different imaging directions from each other, it is sufficient that positions of the images corresponding to the same point correspond to each other between the images.

Furthermore, in the above embodiment, a case has been described where the quality of the classification result is determined in image units. However, the embodiment is not limited to this. The machine learning apparatus may determine the quality for each unit of the class classification. In this case, in the single image, a region of which the classification result is “good” and a region of which the classification result is “poor” exist. Furthermore, in this case, the machine learning apparatus does not generate the synthetic pseudo label in image units and generates the synthetic pseudo label for each region of which the classification result is “good”. Then, the machine learning apparatus may assign the synthetic pseudo label generated from the region of which the classification result is “good”, corresponding to the position of the region, for the region of which the classification result is “poor” in each image. Furthermore, regarding the region of which the classification result is “good” in each image, it is sufficient that the machine learning apparatus assign the classification result of the region as the label.

Furthermore, in the above embodiment, a mode in which the machine learning program is stored (installed) in the storage unit in advance has been described. However, the embodiment is not limited to this. The program according to the disclosed technology may also be provided in a form stored in a storage medium such as a Compact Disc Read Only Memory (CD-ROM), a Digital Versatile Disc (DVD-ROM), or a Universal Serial Bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute processing comprising:
in a case where a machine learning model classifies a first image based on a value less than a threshold, generating training data in which a classification result of a second region of a second image that corresponds to a position of a first region of the first image is labeled to the first region, based on a classification result obtained by classifying the second image based on a value equal to or more than the threshold by the machine learning model; and
training the machine learning model based on the training data.

2. The non-transitory computer-readable recording medium according to claim 1, wherein
a case where the machine learning model classifies the first image based on the value less than the threshold is a case where an average of output values when each of a plurality of regions that includes the first region in the first image is classified is less than the threshold.

3. The non-transitory computer-readable recording medium according to claim 1, wherein
a case where the machine learning model classifies the first image based on the value less than the threshold is a case where an output value when the first region in the first image is classified is less than the threshold, and
the classification result obtained by classifying the second image based on the value equal to or more than the threshold by the machine learning model is a classification result of the second region obtained by classifying the second region of the second image obtained by inputting the second image into the machine learning model based on the value equal to or more than the threshold.

4. The non-transitory computer-readable recording medium according to claim 2, wherein
the output value is a value that indicates confidence of the classification result by the machine learning model.

5. The non-transitory computer-readable recording medium according to claim 1, wherein
the processing of generating the training data includes processing of generating the training data in which a classification result of a third region is labeled to the third region of the first image, in a case where the third region of the first image is classified based on the value equal to or more than the threshold.

6. The non-transitory computer-readable recording medium according to claim 1, wherein
the processing of generating the training data includes processing of generating training data in which a classification result of the second region of the second image that corresponds to a position of a fourth region of a third image generated by using at least one of the first image or the second image or a combination of the first image and the second image is labeled to the fourth region.

7. The non-transitory computer-readable recording medium according to claim 1, wherein
the classification result of the second region is a probability that the second region is classified into each of a plurality of classes, and
the processing of labeling includes assigning a label that corresponds to a class with the highest probability that the second region is classified to the first region, based on a classification result of the second region of a plurality of the second images.

8. A machine learning apparatus comprising:
a memory; and
a processor coupled to the memory and configured to:
in a case where a machine learning model classifies a first image based on a value less than a threshold, generate training data in which a classification result of a second region of a second image that corresponds to a position of a first region of the first image is labeled to the first region, based on a classification result obtained by classifying the second image based on a value equal to or more than the threshold by the machine learning model; and
train the machine learning model based on the training data.

9. The machine learning apparatus recording medium according to claim 8, wherein
a case where the machine learning model classifies the first image based on the value less than the threshold is a case where an average of output values when each of a plurality of regions that includes the first region in the first image is classified is less than the threshold.

10. The machine learning apparatus according to claim 8, wherein
a case where the machine learning model classifies the first image based on the value less than the threshold is a case where an output value when the first region in the first image is classified is less than the threshold, and
the classification result obtained by classifying the second image based on the value equal to or more than the threshold by the machine learning model is a classification result of the second region obtained by classifying the second region of the second image obtained by inputting the second image into the machine learning model based on the value equal to or more than the threshold.

11. The machine learning apparatus according to claim 9, wherein
the output value is a value that indicates confidence of the classification result by the machine learning model.

12. The machine learning apparatus according to claim 8, wherein
the processor generates the training data in which a classification result of a third region is labeled to the third region of the first image, in a case where the third region of the first image is classified based on the value equal to or more than the threshold.

13. The machine learning apparatus according to claim 8, wherein
the processor generates training data in which a classification result of the second region of the second image that corresponds to a position of a fourth region of a third image generated by using at least one of the first image or the second image or a combination of the first image and the second image is labeled to the fourth region.

14. The machine learning apparatus according to claim 8, wherein
the classification result of the second region is a probability that the second region is classified into each of a plurality of classes, and
the processing of labeling includes assigning a label that corresponds to a class with the highest probability that the second region is classified to the first region, based on a classification result of the second region of a plurality of the second images.

15. A machine learning method comprising:
in a case where a machine learning model classifies a first image based on a value less than a threshold, generating training data in which a classification result of a second region of a second image that corresponds to a position of a first region of the first image is labeled to the first region, based on a classification result obtained by classifying the second image based on a value equal to or more than the threshold by the machine learning model; and
training the machine learning model based on the training data.

16. The machine learning method according to claim 15, wherein
a case where the machine learning model classifies the first image based on the value less than the threshold is a case where an average of output values when each of a plurality of regions that includes the first region in the first image is classified is less than the threshold.

17. The machine learning method according to claim 15, wherein
a case where the machine learning model classifies the first image based on the value less than the threshold is a case where an output value when the first region in the first image is classified is less than the threshold, and
the classification result obtained by classifying the second image based on the value equal to or more than the threshold by the machine learning model is a classification result of the second region obtained by classifying the second region of the second image obtained by inputting the second image into the machine learning model based on the value equal to or more than the threshold.

18. The machine learning method according to claim 16, wherein
the output value is a value that indicates confidence of the classification result by the machine learning model.

19. The machine learning method according to claim 8, wherein
a processing of generating the training data includes processing of generating the training data in which a classification result of a third region is labeled to the third region of the first image, in a case where the third region of the first image is classified based on the value equal to or more than the threshold.
